(19) United States
(12) Patent Application Publication
(10) Pub. No.: US 2025/0110062 A1
(43) Pub. Date: Apr. 3, 2025

(54) X-RAY CALORIMETER

(71) Applicant: Analex Corporation, Chantilly, VA (US)

(72) Inventors: George Williams, Colorado Springs, CO (US); Todd Evan Vande Brake, Peyton, CO (US); Gary Lee Paderewski, Colorado Springs, CO (US)

(21) Appl. No.: 18/480,087

(22) Filed: Oct. 3, 2023

(51) Int. Cl. G01K 17/00; G01K 7/02

(52) U.S. Cl. CPC G01N 23/02

(57) ABSTRACT

A calorimeter that includes one or more cloth thermal insulators that are disposed between an absorber and another component of the calorimeter. For example, the absorber (e.g., comprising graphite) may be configured receive the electromagnetic radiation (e.g., X-rays) through an aperture, and may be configured to convert such electromagnetic radiation to heat. The one or more cloth thermal insulators (e.g., ceramic cloths) may be disposed between the absorber and the aperture, between the absorber and a housing of the calorimeter, and/or between the absorber and a retainer body of the calorimeter. For example, the one or more cloth thermal insulators may sandwich the absorber such that the absorber is only in direct contact with the one or more cloth thermal insulators and a thermal sensor (e.g., a thermocouple). Thus, the absorber may be secured by the one or more cloth thermal insulators.

### STATEMENT OF GOVERNMENTAL INTEREST

This invention was made with Government support under Contract No. N00030-15-C-0029 awarded by the United States Navy/Strategic Systems Programs. The U.S. Government has certain rights in the invention.

### TECHNICAL FIELD

The present disclosure relates generally to measurement devices and, in particular, as an X-ray calorimeter for measuring X-ray energy, and a method of using the X-ray calorimeter.

### BACKGROUND

X-ray calorimeters derive the energy deposited from an X-ray radiation source by converting X-ray energy into heat. For example, such an X-ray calorimeter may be mounted to a test snout in a test chamber during testing at the National Ignition Facility (NIF) at Lawrence Livermore National Labs.

An absorber of an X-ray calorimeter may receive X-rays and convert such to heat (e.g., as a result of X-rays colliding with atoms of the absorber), and a thermocouple that is attached to the absorber and measures a temperature of the absorber as it converts X-rays to heat.

Some absorbers are held in place by four rods that extending radially inwardly from a body of the X-ray calorimeter and are disposed every 90° circumferentially around an absorber and that are each received in a corresponding notch of such an absorber. Holding an absorber in place with rigid rods in such a manner can result in significant heat leakage through the rods.

Thus, a calculated total X-ray energy, received by the absorber, that is determined based on the temperature measured by the thermocouple may underrepresent the actual total amount of X-ray energy received by the absorber.

Accordingly, a process and device are needed to increase the accuracy of the calculated total electromagnetic energy that is received by the absorber, for example, in an X-ray test environment.

### SUMMARY

The present application provides for a calorimeter that includes one or more cloth thermal insulators that are disposed between an absorber and another component of the calorimeter. For example, the absorber (e.g., comprising graphite) may be configured receive the electromagnetic radiation (e.g., X-rays) through an aperture, and may be configured to convert such electromagnetic radiation to heat. The one or more cloth thermal insulators (e.g., ceramic cloths) may be disposed between the absorber and the aperture, between the absorber and a housing of the calorimeter, and/or between the absorber and a retainer body of the calorimeter. For example, the one or more cloth thermal insulators may sandwich the absorber such that the absorber is only in direct contact with the one or more cloth thermal insulators and a thermal sensor (e.g., a thermocouple). Thus, the absorber may be secured by the one or more cloth thermal insulators.

As discussed above, the accuracy of a calculated total X-ray energy received by an absorber may be negatively impacted by heat leakage that reduces the temperature of the absorber that is measured by the thermal sensor. Thus, thermally and electrically isolating the absorber with one or more cloth thermal insulators, which may have a significantly lower heat transfer coefficient compared to the four rods used in some calorimeters, can provide for significantly reduced heat leakage compared to such calorimeters with four rods. Accordingly, the accuracy of a calculated total electromagnetic energy may be improved, over such calorimeters with rods securing an absorber, by utilizing an electromagnetic calorimeter that secures an absorber with one or more cloth thermal insulators.

Reducing heat leakage compared to other calorimeters may provide for more accurate measurements compared to calorimeters that, for example, include four rigid rods to secure an absorber. For example, reducing heat leakage may provide for more heat to remain with the absorber and thus result in a comparatively higher temperature that less underrepresents the actual total amount of X-ray energy received by the absorber, compared to such known calorimeters.

Moreover, the inventors of the present application recognize that thermal mass and thermal isolation of the absorber are critical parameters for the electromagnetic calorimeter. The thermal mass of the absorber must be small enough to produce a temperature rise large enough to be measured. Also, thermally isolating the absorber provides for preventing the heat generated from the X-ray exposure from dissipating into the surrounding structure, thus affecting the temperature measurement.

According to an embodiment of the present disclosure, a calorimeter may comprise a housing, an aperture body, an absorber, a thermal sensor, a retainer body, and one or more cloth thermal insulators. The aperture body may be at least partially disposed within the housing and define an aperture configured to allow electromagnetic radiation to move pass through a first end of the aperture body and out a second end of the aperture body. The absorber may be disposed within the housing and configured to receive the electromagnetic radiation. The thermal sensor may be thermally coupled to the absorber, such that the thermal sensor is configured to detect a change in temperature of the absorber. The retainer body may be at least partially disposed within the housing and configured to limit movement of the absorber away from the aperture body, wherein the absorber is disposed between the aperture body and the retainer body. The one or more cloth thermal insulators may be disposed between the absorber and the aperture body, between the absorber and the housing, and/or between the absorber and the retainer body.

According to another embodiment of the present disclosure, a method of operating a calorimeter may include directing electromagnetic radiation through an aperture, defined by an aperture body of the calorimeter, to an absorber. The method may include receiving the electromagnetic radiation with the absorber, thereby heating the absorber. The method may include detecting a change in temperature of the absorber caused by the electromagnetic radiation. The method may include thermally insulating the absorber with one or more cloth thermal insulators.

Any of the features of the above and below disclosed embodiments of the calorimeter may be used in combination with one another.

### BRIEF DESCRIPTION OF THE DRAWINGS

The foregoing summary, as well as the following detailed description of illustrative embodiments of the calorimeter of the present application, will be better understood when read in conjunction with the appended drawings. For the purposes of illustrating the apparatus of the present application, there is shown in the drawings illustrative embodiments. It should be understood, however, that the application is not limited to the precise arrangements and instrumentalities shown. In the drawings:

FIG. 1A is an oblique top view of a test mount assembly.

FIG. 1B is an oblique top view of the test mount of FIG. 1 with its top removed so that multiple electromagnetic calorimeters held by a mount of the test mount assembly are visible.

FIG. 2 is an oblique view of one of the electromagnetic calorimeters of FIG. 1B.

FIG. 3 is a side cross-sectional view of the electromagnetic calorimeter of FIG. 2, including cloth thermal insulators that abut an absorber.

FIG. 4 is a side view of the electromagnetic calorimeter of FIG. 2 along with a connector and flexible cable tube.

FIG. 5 is an oblique exploded view of the electromagnetic calorimeter of FIG. 2.

FIG. 6 is a plot representing temperatures detected by a thermal sensor of the electromagnetic calorimeter of FIG. 2 versus time.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

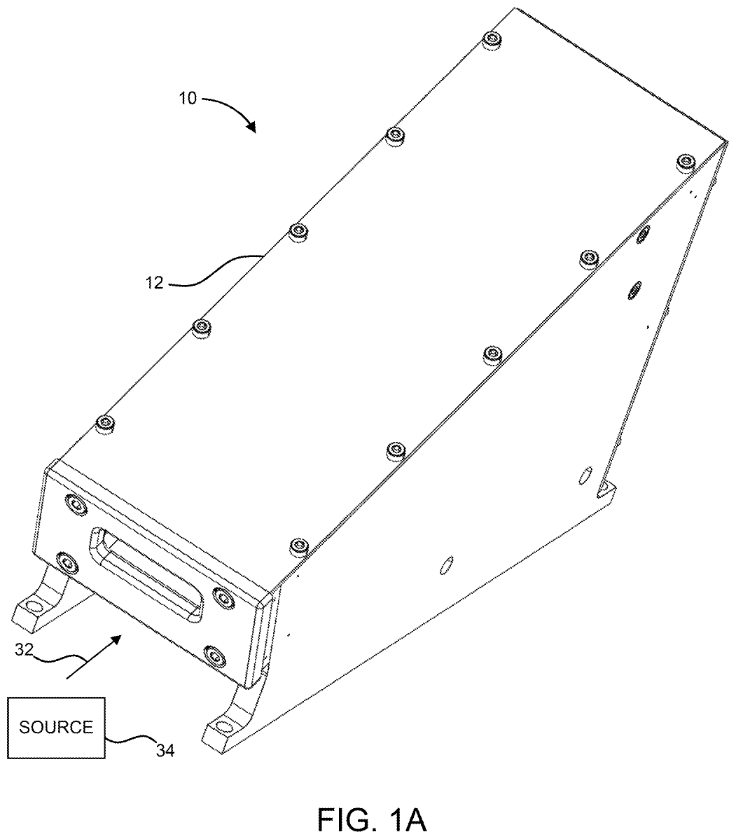

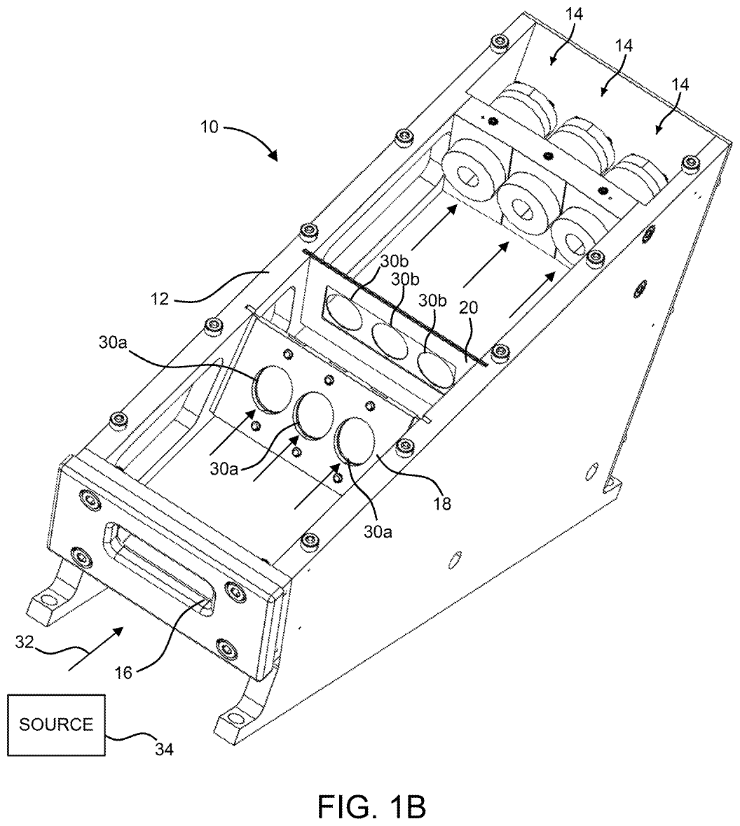

Referring to FIGS. 1A and 1B, a test mount assembly 10 is illustrated. The test mount assembly 10 may include a test mount 12 that may secure one or more electromagnetic calorimeters 14 relative to a test mount aperture 16 and electromagnetic filter holders 18, 20.

One or both of the electromagnetic filter holders 18 and 20 may define openings 30a, 30b (e.g., circular openings) that are configured to receive electromagnetic radiation from the test mount aperture 16. Also, one or both of the electromagnetic filter holders 18 and 20 may include filter material that spans a corresponding opening the electromagnetic filter holders 18 and 20. For example, the electromagnetic filter holder 18 may include filter material that spans the respective openings 30a. The filter material may be a micron thick.

The electromagnetic filter holders 18 and 20 may be angled with respect to one another. For example, the openings 30a of the electromagnetic filter holder 18 may be configured to receive electromagnetic radiation from the test mount aperture 16 at a front end of the electromagnetic filter holder 18. The openings 30a may define respective central axes that extend from a back end of the electromagnetic filter holder 18 away from the front end into the test mount 12. Angling the electromagnetic filter holder 18 such that the central axes do not extend through corresponding apertures defined by the electromagnetic filter holder 20, may prevent blow off of filter material of a filter spanning the openings of the electromagnetic filter holder 18 from reaching and damaging the electromagnetic calorimeters 14.

During use, a portion of electromagnetic radiation 32 (e.g., X-rays with a fluence of 0.2-2.0 cal/cm²), represented by black arrows in FIG. 1B, travels along a pathway from a source 34 (e.g., an ampoule that generates X-rays upon being impinged with a laser beam) to the electromagnetic calorimeters 14. For example, the portion of electromagnetic radiation 32 may travel from the source 34 through the test mount aperture 16, then to the openings 30a, then to the openings 30b, and then to the electromagnetic calorimeters 14.

In an embodiment, two or less electromagnetic calorimeters receive a corresponding portion of the electromagnetic radiation. In another embodiment, more than three electromagnetic calorimeters receive a corresponding portion of the electromagnetic radiation.

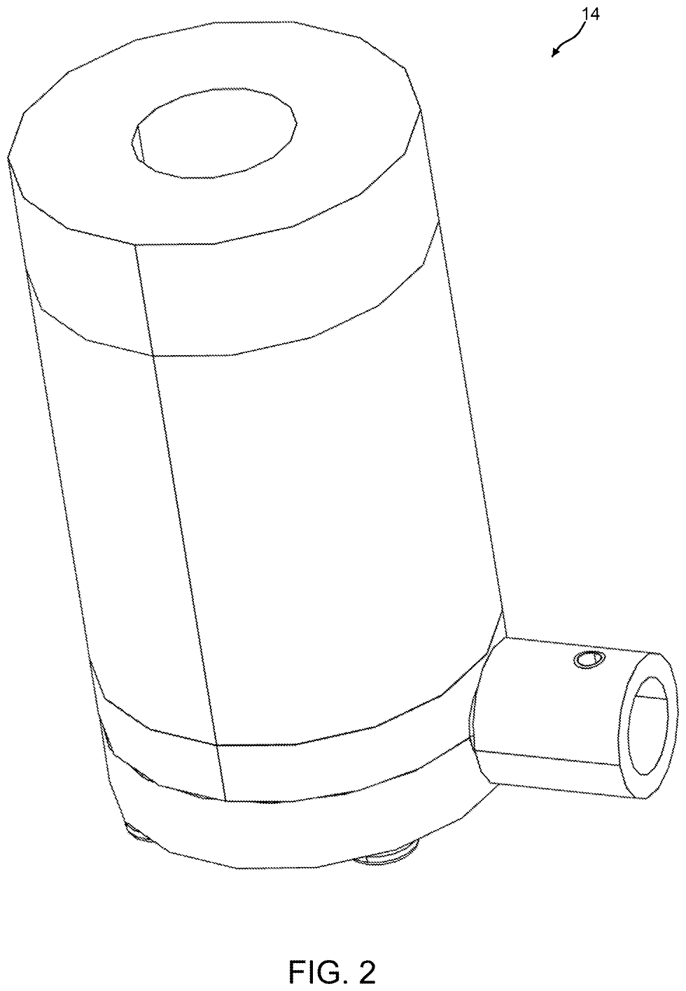

Turning to FIG. 2, one of electromagnetic calorimeters 14 is illustrated. In an embodiment, all of the electromagnetic calorimeters 14 are identical.

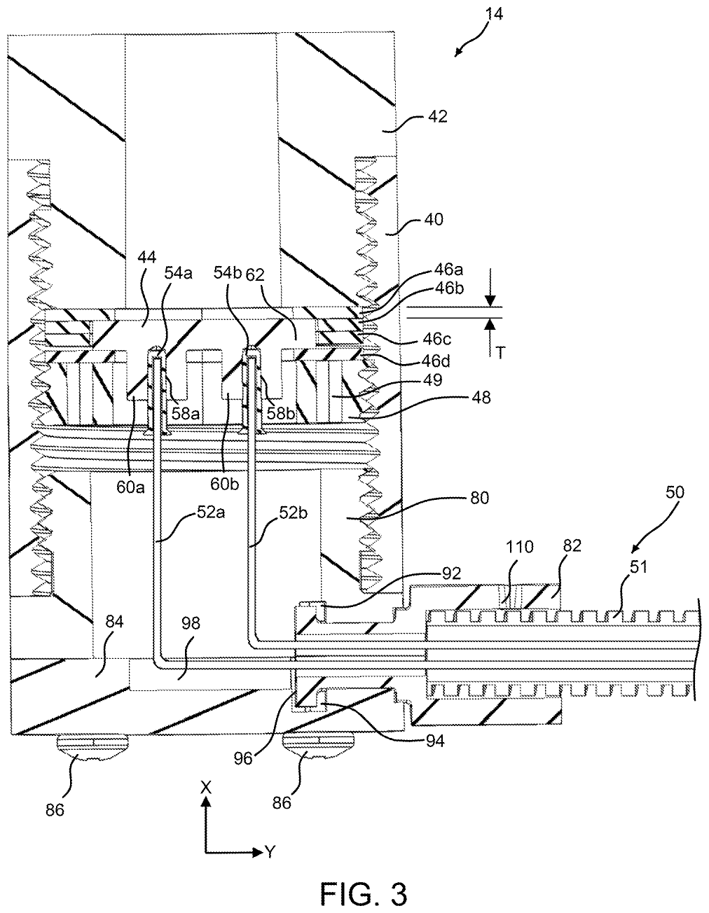

Referring now to FIGS. 3-5, the electromagnetic calorimeter 14 may include a housing 40, an aperture body 42, an absorber 44, and cloth thermal insulators 46a-46d that are configured to secure the absorber 44. For example, the electromagnetic calorimeter 14 may include a retaining ring 48 (an example of a retainer body) that is configured to sandwich the absorber 44 and the cloth thermal insulators 46a-46d with the aperture body 42.

The cloth thermal insulators 46a-46d may be configured to thermally and electrically isolate the absorber 44 from the housing 40, the aperture body 42, and the retaining ring 48.

The aperture body 42 may define a through hole that receives the corresponding portion of the electromagnetic radiation 32 (shown in FIG. 1B). The through hole may be configured such that the portion of the electromagnetic radiation 32 impinges the absorber 44. Impinging the absorber 44 with the portion of electromagnetic radiation 32 may heat the absorber 44, thereby increasing a temperature of the absorber 44.

The through hole of the aperture body may define a cross-sectional area of 0.08 inches squared (in²) (0.5 cm²). In some embodiments, the cross-sectional area may be less than or greater than 0.08 in² (0.5 cm²). For example, the through hole may define a diameter anywhere from 0.2 in to 0.5 in. The through hole may define a diameter anywhere from 0.3 in to 0.4 in (e.g., 0.315 in). This through hole may define an aperture diameter that may allow for maximum exposure of the absorber 44 without exposing other components within the electromagnetic calorimeter 14. In other words, the aperture diameter illustrated in FIGS. 2 and 3 may be the maximum sized aperture diameter for the configuration of the electromagnetic calorimeter 14 illustrated in FIGS. 2 and 3. In an embodiment, the absorber 44 may be larger and thus accommodate the aperture diameter being larger. Also, in an embodiment, the aperture diameter may be smaller than the aperture diameter illustrated in FIGS. 2 and 3, thus limiting the amount of energy deposited onto the absorber at a lever below that of the aperture diameter illustrated in FIGS. 2 and 3.

In an embodiment, the aperture body is at least partially disposed within the housing. For example, a portion of the aperture body may be entirely disposed within the housing. Another portion of the aperture body may be external to the housing.

The aperture body 42 may be made of graphite (e.g., AXM-5Q graphite). For example, an entirety of the aperture body 42 may be graphite. The graphite of the aperture body 42 may prevent spalling and vaporization of the aperture body 42 when the electromagnetic radiation impinges the aperture body 42. Spalling or vaporizing of any amount of material from the aperture body 42 can result in material depositing onto the absorber 44, and thus adversely affect temperature measurements of the absorber 44.

The retaining ring 48 and the aperture body 42 may be configured to attach to the housing 40. For example, the retaining ring 48 and the aperture body 42 may threadedly engage with a radially inwardly facing surface of the housing 40, such that the retaining ring 48 and the aperture body 42 are longitudinally fixed relative to the housing 40. Accordingly, the absorber 44 may be longitudinally fixed relative to the housing 40 when sandwiched longitudinally by the cloth thermal insulators 46a-46d and by the aperture body 42 and the retaining ring 48.

The retaining ring 48 may include one or more tool engagement portions 49. For example, each tool engagement portion 49 may define a respective cylindrical through hole that each extend along a longitudinal axis X. The through holes may be diametrically opposed to one another relative to the longitudinal axis X.

In an embodiment, the retaining ring is at least partially disposed within the housing. For example, the retaining ring may be entirely disposed within the housing.

Referring now to FIG. 3 alone, the electromagnetic calorimeter 14 may include a thermal sensor 50 that is thermally coupled to the absorber 44. The thermal sensor 50 may include two thermocouples 52a, 52b, which may extend through a flexible cable 51 (e.g., an armored flex cable).

The cloth thermal insulators 46a-46d may be configured to thermally and electrically isolate absorber 44 from every other component of the electromagnetic calorimeter 14, except for the thermal sensor 50.

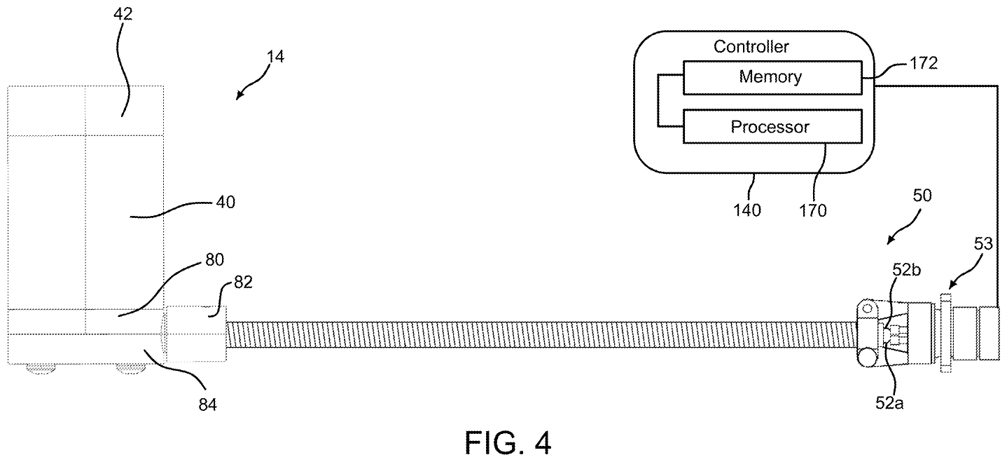

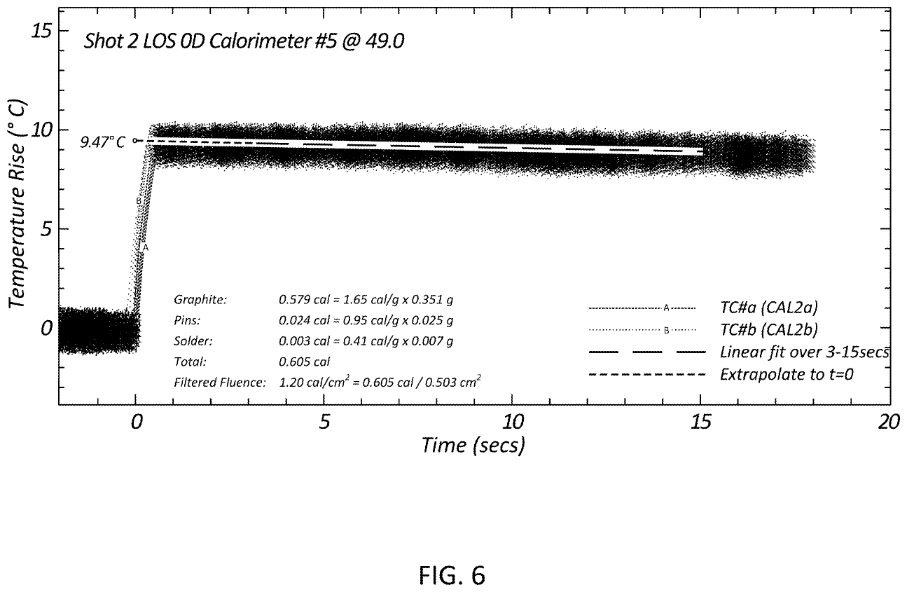

The thermal sensor 50 may include a connector 53 that receives one end of the thermocouples 52a, 52b. For example, the connector 53 may be configured to connect to a wiring harness (not shown) or terminal (not shown) to provide a voltage from the thermocouples 52a, 52b that is based on a change in temperature of the absorber 44 over time (see e.g., FIG. 6). The wiring harness or terminal may be configured to provide the voltage to a controller 140 (shown in FIG. 4, e.g., an oscilloscope) to provide the temperature of the absorber 44 over time (e.g., as shown in FIG. 6). As discussed above, the temperature of the absorber 44 may be based on the portion of electromagnetic radiation 32 that travels through the aperture body 42 to the absorber 44.

For example, another end of the thermocouples 52a, 52b may each be coupled to the absorber 44. Each thermocouple 52a, 52b may terminate in a respective solder cup 54a, 54b that is press fit a respective recess 58a, 58b of the absorber 44. The recesses 58a, 58b may each be formed in a respective protrusion 60a, 60b of the absorber.

Each thermocouple 52a, 52b may be soldered to the interior of the respective solder cup 54a, 54b. The mass of the solder may be kept to a minimum for each solder cup 54a, 54b.

A determined amount of electromagnetic energy may be based on a total thermal mass M_{T} of the absorber 44, the solder cups 54a, 54b, and the solder. The total thermal mass M_{T} is based on the mass of each of the absorber 44, the solder cups 54a, 54b, and the solder. Accordingly, the mass of each of the absorber 44, the solder cups 54a, 54b, and the solder may be measured and/or determined prior to determining the amount of electromagnetic energy. In an embodiment, the mass of each of the absorber 44 and the solder cups 54a, 54b is measured prior to soldering, and the mass of the combination of the absorber 44, the solder cups 54a, 54b, and the solder is measured after soldering, and the total thermal mass M_{T} is determined based on the mass measurements. Calculations based on such masses are discussed further below with reference to FIG. 6.

Each thermocouple 52a, 52b may comprise two conductive wires (e.g., a positive wire and a negative wire, not shown). For example, the thermocouples 52a, 52b may be type E.

The thermocouples 52a, 52b may provide for determining a quality of an electrical connection and a thermal connection between the thermocouples 52a, 52b and the absorber 44. For example, electrical resistance across the absorber 44 between the ends of the thermocouples 52a, 52b that is coupled to the absorber 44 may be measured and compared to a predetermined electrical resistance of the absorber 44 to determine the quality of the electrical connection and the thermal connection. The electrical resistance may be measured through the positive wires (not shown) of the thermos couples 52a, 52b.

The protrusions 60a, 60b may extend longitudinally along the longitudinal axis X such that the recesses 58a, 58b open along the longitudinal axis. For example, the protrusions 60a, 60b may be cylindrical and extend longitudinally away from a flange 62 that is defined by the absorber 44.

The flange 62 may be configured to be secured by the cloth thermal insulators 46a-46d. For example, the flange 62 may extend radially beyond the protrusions 60a, 60b from the longitudinal axis X such that the cloth thermal insulators 46a and 46d abut opposing longitudinally facing surfaces of the flange 62, thereby sandwiching the flange 62. Radially inwardly facing surfaces of the cloth thermal insulators 46b and 46c may abut a radially outwardly facing surface of the flange 62.

Accordingly, the cloth thermal insulators 46a-46d may be disposed between the absorber 44 and the aperture body 42, between the absorber 44 and the housing 40, and/or between the absorber 44 and the retaining ring 48.

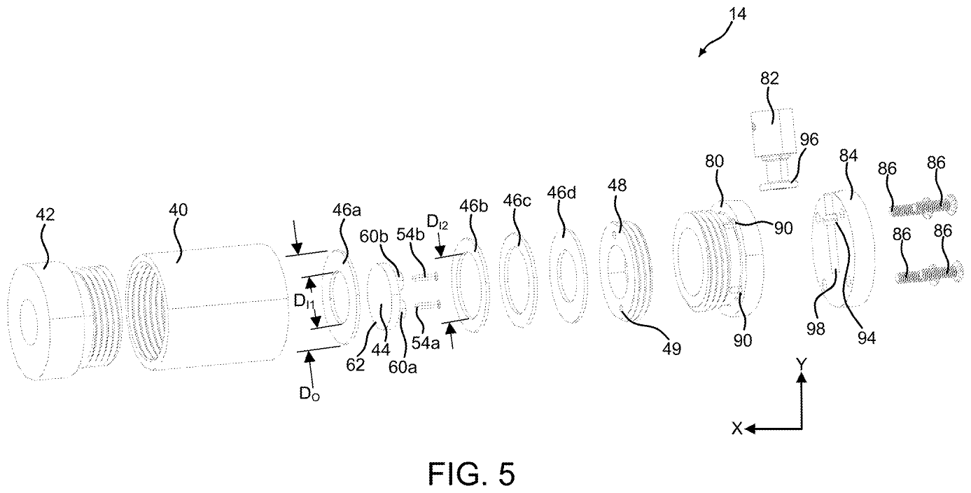

Referring now to FIGS. 3 and 5, cloth thermal insulators 46a-46d may define an outer diameter D_{O} of 0.64 in. In an embodiment, the outer diameter D_{O} is anywhere from 0.63 in to 0.65 in.

The cloth thermal insulators 46a, 46d may define an inner diameter D_{I1} of 0.36 in. In an embodiment, the inner diameter D_{I1} is anywhere from 0.35 in to 0.37 in.

The cloth thermal insulators 46b, 46c may define an inner diameter D_{I2} that is greater than the inner diameter D_{I1} of the cloth thermal insulators 46a, 46d. For example, the inner diameter D_{I2} may be 0.46 in. In an embodiment, the inner diameter D_{I2} is anywhere from 0.45 in to 0.47 in.

The cloth thermal insulators 46a-46d may have a thickness T of 0.032 in along the longitudinal axis X. In an embodiment, the thickness T is anywhere from 0.02 in to 0.06 in.

In some embodiments, the cloth thermal insulators each have the same thickness. In other embodiments, at least one of the cloth thermal insulators has a different thickness from the other cloth thermal insulators.

The cloth thermal insulators 46a-46d may each be formed of a distinct ceramic cloth insulator (e.g., loose weave ceramic cloth, such as High-Temperature Ceramic Fiber Pipe Insulation, Alumina Oxide part number 87575K83 by McMaster-Carr®). For example, each of the cloth thermal insulators 46a-46d may be ring shaped with respective flat longitudinally facing surfaces and a cylindrical radially outwardly facing surface.

In an embodiment, three or less distinct cloth thermal insulators each abut the absorber. In another embodiment, five or more distinct cloth thermal insulators each abut the absorber.

The electromagnetic calorimeter 14 may include an end cap 80, a cable clamp 82, a retainer 84, and fasteners 86 that are configured to secure the retainer 84 to the end cap 80.

The end cap 80 may define a through hole such that the thermocouples 52a, 52b are extendable through the end cap 80 along the longitudinal axis X.

The end cap 80 may be configured to attached to the housing 40. For example, the end cap 80 may define a threaded portion that threadedly engage with the internal threads of the housing 40, such that the end cap 80 is longitudinal fixed relative to the housing 40.

The end cap 80 may include one or more fastener receiving openings. For example, the end cap 80 may include four threaded holes 90 (two are visible in FIG. 5). The threaded holes 90 may be identical and equilaterally spaced about the longitudinal axis X. For example, the threaded holes 90 may be configured to threadedly engage with the fasteners 86 to secure the retainer 84 to the end cap 80.

The end cap 80 and the retainer 84 may define respective recesses 92, 94 that face one another along the longitudinal axis X to receive a corresponding portion of the cable clamp 82. For example, the recesses 92, 94 may receive a flange 96 of the cable clamp 82.

Thus, when the flange 96 of the cable clamp 82 is disposed in the recesses 92, 94 and the fasteners 86 are secured to the end cap 80, the cable clamp 82 may be fixed relative to the end cap 80 and the retainer 84.

The retainer 84 may define a sensor receiving groove 98 that extends from the recess 94, thereby providing space for the thermal sensor 50. For example, the thermocouple 52a may extend into the sensor receiving groove 98 from an opening of the cable clamp 82 that extends laterally along a lateral axis Y.

The cable clamp 82 may be configured to clamp against an outer surface of the flexible cable 51. For example, the cable clamp 82 may define a through hole 110 that is configured to receive a fastener (not shown) that when in a locked position locks the flexible cable 51 in a through hole of the cable clamp 82. For example, the fastener may be a threaded set screw (not shown) that is configured to threadedly couple to internal threading of the through hole 110, and when tightened the threaded set screw may abut against the outer surface of the flexible cable 51, thereby locking the flexible cable 51 relative to the cable claim 82.

The housing 40, the end cap 80, the cable clamp 82, and the retainer 84 may be made of a metal. For example, each of the housing 40, the end cap 80, the cable clamp 82, and the retainer 84 may be made of aluminum. Each of the housing 40, the end cap 80, the cable clamp 82, and the retainer 84 may be entirely made of aluminum

The retaining ring 48 may be made of a different material. For example, the retaining ring 48 may be made of a polymer, such as an acetal homopolymer (e.g., DELRIN® (e.g., white) from DUPONT®).

During assembly, the absorber 44, the cloth thermal insulators 46a-46d, and the solder cups 54a, 54b may be placed within the housing, along with the respective ends of the thermocouples 52a, 52b that are soldered to the solder cups 54a, 54b. The retaining ring 48 may be threadedly engaged with the internal threading of the housing 40 and rotated until the retaining ring 48 reaches a predetermined position at which the retaining ring 48 abuts the cloth thermal insulator 46d.

The aperture body 42 may be threadedly engaged with the internal threading of the housing 40 and rotated until the aperture body 42 reached a predetermined position at which the aperture body abuts the cloth thermal insulator 46a.

The end cap 80 may be threadedly engaged with the internal threading of the housing 40 and tightened until reaching a predetermined position relative to the housing 40. The cable clamp 82 may be positioned such that the flange 96 is disposed in the recess 92 of the end cap 80. The retainer 84 may be positioned such that the recess 94 receives the flange 96. The fasteners 86 may fix the end cap 80 and the retainer 84 to one another when the cable clamp 82 is positioned between the end cap 80 and the retainer 84, where the flange 96 is disposed in the recesses 92, 94.

The flexible cable 51 may be positioned within the cable clamp 82 such that locking of the fastener (not shown) of the cable clamp 82 fixes the cable clamp 82 and the flexible cable 51 together.

The connector 53 may be coupled to respective ends of the thermocouples 52a, 52b along with a respective end of the flexible cable 51, such that the flexible cable 51 and the respective ends of the thermocouples 52a, 52b are fixed to the connector 53.

At each step of assembly of the electromagnetic calorimeter 14, the mass of each component may be measured or determined.

Turning to FIG. 6, an example of temperature measurements of the absorber 44 taken by the thermal sensor 50 over time is illustrated, with light plot points “A” representing measurements from the thermocouple 52a, and dark plot points “B” representing measurements from the thermocouple 52b. For example, during use, the portion of electromagnetic radiation 32 may travel through the aperture body 42 and impinge the absorber 44, thereby increasing the temperature of the absorber 44 based on the portion of electromagnetic radiation 32. The temperature of the absorber 44 measured by each thermocouple 52a, 52b may increase by about 9.5° C. within less than half a second.

A linear fit from 3 seconds to 18 seconds is represented with long dashes, and an extrapolation of the linear fit to 0 seconds (at 9.47° C.) is represented with short dashes.

With reference to FIGS. 3 and 6, the absorber 44 may be entirely formed of 0.351 grams (g) of graphite, with a specific heat of 1.65 calories (cal)/g, and thus a thermal mass (also referred to as a heat capacity) of .579 cal. The solder cups 54a, 54b (also referred to as pins) may be formed of 0.025 g of gold or tin plated steel, with a specific heat of 0.215 cal/g, and thus a thermal mass of .024 cal. The solder may be formed of 0.007 g of silver solder, with a specific heat of 0.41 cal/g, and thus a thermal mass of .003 cal. Thus, the total thermal mass of the combination of the absorber 44, the solder cups 54a, 54b, and the solder may be .605 cal.

Accordingly, the filtered fluence may be 32.45 Joules (J)/in² (1.20 cal/centimeters-squared (cm²)), based on the total thermal mass of the combination 2.531 J (0.605 cal) divided by the area of the through hole/aperture of the aperture body 42 0.078 in² (0.503 cm²).

The same electromagnetic calorimeter 14 may be re-used for multiple independent tests to measure the electromagnetic energy received during a test event. For example, a single electromagnetic calorimeter 14 may be used to measure the electromagnetic energy of 12-15 different test events.

Referring again to FIG. 4, the controller 140 may include a processor 170 operatively connected to memory 172. The processor 170 may be configured to determine the linear fit and the extrapolation of the linear fit based on, for example, the temperature of the absorber 44 over time. The processor 170 may be configured to determine the total electromagnetic energy based on the temperature of the absorber 44 over time during a given test.

The controller 140 may be configured to send and/or receive signals to receive information from or direct operation of the one or more components of the electromagnetic calorimeter 14. For example, the controller 140 may be configured to receive data (e.g., voltage output) from the thermal sensor 50 (e.g., via a wiring harness or terminal). The controller 140 may be configured to store information received from the thermal sensor 50, for example, in the memory 172.

The controller 140 may include, or be operatively connected to, one or more electromagnetic calorimeters 14 (see e.g., FIG. 1B) and/or other sensors configured to detect and measure various other parameters of the electromagnetic radiation 32.

The processor 170 may be configured to connect with and communicate with the memory 172, which may be configured to receive and store the measured values. The memory 172 may include a random access memory (RAM) and/or a computer-readable storage medium, such as a read-only memory (ROM) or non-volatile RAM (NVRAM), for storing basic routines for starting and/or operating the processor 170, which may be configured as a controller, and/or another component of the electromagnetic calorimeter 14 and to transfer information between the various components and devices of the test mount assembly 10. The memory 172 may also store other software components necessary for the operation of the processor 170 and/or other components of the test mount assembly 10 including an operating system, software implementing a cleaning method as described herein, and/or the like. The processor 170 may include, or may be connected to, or otherwise in communication with, computer-readable storage media to store and retrieve information, such as program modules, data structures, or other data. It should be appreciated by those skilled in the art that computer-readable storage media may be any available media that provides for the storage of non-transitory data and that may be accessed by the processor 170. By way of non-limiting example, the computer-readable storage media may include volatile and non-volatile storage media, transitory computer-readable storage media, non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

The following are a number of nonlimiting EXAMPLES of aspects of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, calorimeter may include a housing. The calorimeter may also include an aperture body at least partially disposed within the housing and defining an aperture configured to allow electromagnetic radiation to move pass through a first end of the aperture body and out a second end of the aperture body. The calorimeter may furthermore include an absorber disposed within the housing and configured to receive the electromagnetic radiation. The calorimeter may in addition include a thermal sensor thermally coupled to the absorber, such that the thermal sensor is configured to detect a change in temperature of the absorber. The calorimeter may moreover include a retainer body at least partially disposed within the housing and configured to limit movement of the absorber away from the aperture body, where the absorber is disposed between the aperture body and the retainer body. The calorimeter may also include one or more cloth thermal insulators disposed between the absorber and the aperture body, between the absorber and the housing, and/or between the absorber and the retainer body. Other embodiments of this aspect include corresponding computer systems, apparatus, and computer programs recorded on one or more computer storage devices, each configured to perform the actions of the methods.

Implementations may include one or more of the following features. The calorimeter where the one or more cloth thermal insulators each may include a ceramic cloth. The calorimeter where the one or more cloth thermal insulators each may include one or more loose weave ceramic cloths. The calorimeter where each of the more or more cloth thermal insulators has a thickness of anywhere from 0.02 in to 0.06 in. The calorimeter where the one or more cloth thermal insulators may include at least two first cloth thermal insulator plates that sandwich a radially outer portion of the absorber, and may include at least one second cloth thermal insulator plate that radially inwardly faces the radially outer portion of the absorber. The calorimeter where the absorber may include a non-metallic material. The calorimeter where the absorber may include graphite. The calorimeter where the aperture body may include a non-metallic material. The calorimeter where the housing may include aluminum. The calorimeter where at least one of the one or more cloth thermal insulators defines an inner diameter that is greater than another one of the one or more cloth thermal insulators. The calorimeter where the one or more cloth thermal insulators sandwich a radially outer portion of the absorber and circumscribe the radially outer portion such that the one or more cloth thermal insulators are disposed between the absorber and the aperture body, between the absorber and the housing, and between the absorber and the retainer body. The calorimeter where the absorber is spaced from the aperture, the housing, and the retainer body by the one or more cloth thermal insulators, such that the absorber is not in contact with the aperture, is not in contact with the housing, and is not in contact with the retainer body. The calorimeter where the calorimeter is an X-ray calorimeter. The calorimeter where the retainer body is configured to engage the housing such that the retainer body and the housing are translationally fixed body relative to one another. The calorimeter where the retainer body is threadedly coupled to the housing such that the retainer body is configured to rotate relative to the housing, where rotation of the retainer body relative to the housing results in a change of a distance between the aperture body and the retainer body and resulting in axial movement of the retainer body relative to the housing. The calorimeter where the aperture body defines a through hole with a cross-sectional diameter anywhere from 0.2 inches to 0.5 inches. The calorimeter may include an armored flex cable. Test mount assembly to 21 fixed by the test mount. The calorimeter where the thermal sensor may include at least one thermocouple wire that is thermally coupled to the absorber. The calorimeter where the at least one thermocouple wire is thermally coupled to at least one attachment portion of the absorber. The calorimeter may include at least one solder cup that is attached to a respective one of the at least one thermocouple wire, where the at least one solder cup is configured to couple to the at least one attachment portion of the absorber, such that the at least one thermocouple wire is fixed to and thermally coupled to the absorber. The calorimeter where the at least one solder cup may include two solder cups, the at least one thermocouple wire may include two pairs of thermocouple wires, and each of the two solder cups is attached to respective ends of each respective pair of the two pairs of thermocouple wires. Implementations of the described techniques may include hardware, a method or process, or a computer tangible medium.

In one general aspect, method may include directing electromagnetic radiation through an aperture, defined by an aperture body of the calorimeter, to an absorber. The method may also include receiving the electromagnetic radiation with the absorber, thereby heating the absorber. The method may furthermore include detecting a change in temperature of the absorber caused by the electromagnetic radiation. The method may in addition include thermally insulating the absorber with one or more cloth thermal insulators. Other embodiments of this aspect include corresponding computer systems, apparatus, and computer programs recorded on one or more computer storage devices, each configured to perform the actions of the methods.

Implementations may include one or more of the following features. The method where thermally insulating the absorber may include thermally insulating, with the one or more cloth thermal insulators, the absorber from the aperture body, a housing of the calorimeter, and/or a retainer body of the calorimeter. The method where the one or more cloth thermal insulators are disposed between the absorber and the aperture body, between the absorber and the housing, and/or between the absorber and the retainer body. The method where the electromagnetic radiation is X-ray radiation. The method where insulating the absorber may include thermally isolating the absorber from the aperture body with the one or more cloth thermal insulators. The method where the electromagnetic radiation may include X-rays and the calorimeter is an X-ray calorimeter. The method where the one or more cloth thermal insulators each may include a ceramic cloth. The method where the one or more cloth thermal insulators sandwich a radially outer portion of the absorber and circumscribe the radially outer portion such that the one or more cloth thermal insulators are disposed between the absorber and the aperture body, between the absorber and the housing, and between the absorber and the retainer body. The method where the absorber is spaced from the aperture, the housing, and the retainer body by the one or more cloth thermal insulators, such that the absorber is not in contact with the aperture, is not in contact with the housing, and is not in contact with the retainer body. The method where the retainer body engages the housing such that the retainer body and the housing are translationally fixed body relative to one another. Implementations of the described techniques may include hardware, a method or process, or a computer tangible medium.

In one general aspect, a method of measuring movement of a test specimen may include holding test specimen in a test specimen holder. The method may also include directing an optical beam from an optical probe through a body, that is fixed relative to the test specimen holder, to the test specimen. The method may also include producing a shockwave that propagates through the test specimen such that the optical probe measures the displacement of the test specimen due to the shockwave. The method may also include producing a voltage with an electromagnetic transducer based on movement of the body with the test specimen in a first direction relative to the transducer housing. Other embodiments of this aspect include corresponding computer systems, apparatus, and computer programs recorded on one or more computer storage devices, each configured to perform the actions of the methods.

It should be noted that the illustrations and descriptions of the examples shown in the figures are for exemplary purposes only, and should not be construed limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

Although the disclosure has been described in detail, it should be understood that various changes, substitutions, and alterations can be made herein without departing from the spirit and scope of the present disclosure as defined by the appended claims. Additionally, any of the embodiments disclosed herein can incorporate features disclosed with respect to any of the other embodiments disclosed herein. Moreover, the scope of the present disclosure is not intended to be limited to the particular embodiments described in the specification. As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the invention from including two or more, up to all, of the features. For instance, reference to a device having or defining “one of a X and Y” does not foreclose the device from having both the X and Y.

1. A calorimeter comprising:
a housing;
an aperture body at least partially disposed within the housing and defining an aperture configured to allow electromagnetic radiation to move pass through a first end of the aperture body and out a second end of the aperture body;
an absorber disposed within the housing and configured to receive the electromagnetic radiation;
a thermal sensor thermally coupled to the absorber, such that the thermal sensor is configured to detect a change in temperature of the absorber;
a retainer body at least partially disposed within the housing and configured to limit movement of the absorber away from the aperture body, wherein the absorber is disposed between the aperture body and the retainer body; and
one or more cloth thermal insulators disposed between the absorber and the aperture body, between the absorber and the housing, and/or between the absorber and the retainer body.

2. The calorimeter of claim 1, wherein the one or more cloth thermal insulators each comprise a ceramic cloth.

3. The calorimeter of claim 2, wherein the one or more cloth thermal insulators each comprise one or more loose weave ceramic cloths.

4. The calorimeter of claim 1, wherein each of the more or more cloth thermal insulators has a thickness of anywhere from 0.02 in to 0.06 in.

5. The calorimeter of claim 1, wherein the one or more cloth thermal insulators comprises at least two first cloth thermal insulator plates that sandwich a radially outer portion of the absorber, and comprises at least one second cloth thermal insulator plate that radially inwardly faces the radially outer portion of the absorber.

6. The calorimeter of claim 1, wherein the absorber and/or the aperture body comprises a non-metallic material.

7-9. (canceled)

10. The calorimeter of claim 1, wherein at least one of the one or more cloth thermal insulators defines an inner diameter that is greater than another one of the one or more cloth thermal insulators.

11. The calorimeter of claim 1, wherein the one or more cloth thermal insulators sandwich a radially outer portion of the absorber and circumscribe the radially outer portion such that the one or more cloth thermal insulators are disposed between the absorber and the aperture body, between the absorber and the housing, and between the absorber and the retainer body.

12. The calorimeter of claim 1, wherein the absorber is spaced from the aperture, the housing, and the retainer body by the one or more cloth thermal insulators, such that the absorber is not in contact with the aperture, is not in contact with the housing, and is not in contact with the retainer body.

13. The calorimeter of claim 1, wherein the calorimeter is an X-ray calorimeter.

14. The calorimeter of claim 1, wherein the thermal sensor comprises at least one thermocouple wire that is thermally coupled to the absorber.

15. The calorimeter of claim 14, wherein the at least one thermocouple wire is thermally coupled to at least one attachment portion of the absorber.

16. The calorimeter of claim 15, further comprising at least one solder cup that is attached to a respective one of the at least one thermocouple wire, wherein the at least one solder cup is configured to couple to the at least one attachment portion of the absorber, such that the at least one thermocouple wire is fixed to and thermally coupled to the absorber.

17-19. (canceled)

20. The calorimeter of claim 1, wherein the aperture body defines a through hole with a cross-sectional diameter anywhere from 0.2 inches to 0.5 inches.

21. (canceled)

22. A test mount assembly comprising:
a test mount; and
the calorimeter of claim 1 fixed by the test mount.

23. A method of operating a calorimeter, the method comprising:
directing electromagnetic radiation through an aperture, defined by an aperture body of the calorimeter, to an absorber;
receiving the electromagnetic radiation with the absorber, thereby heating the absorber;
detecting a change in temperature of the absorber caused by the electromagnetic radiation; and
thermally insulating the absorber with one or more cloth thermal insulators.

24. The method of claim 23, wherein thermally insulating the absorber comprises thermally insulating, with the one or more cloth thermal insulators, the absorber from the aperture body, a housing of the calorimeter, and/or a retainer body of the calorimeter.

25. (canceled)

26. The method of claim 23, wherein the electromagnetic radiation is X-ray radiation.

27-29. (canceled)

30. The method of claim 23, wherein the one or more cloth thermal insulators sandwich a radially outer portion of the absorber and circumscribe the radially outer portion such that the one or more cloth thermal insulators are disposed between the absorber and the aperture body, between the absorber and the housing, and between the absorber and the retainer body.

31. The method of claim 23, wherein the absorber is spaced from the aperture, the housing, and the retainer body by the one or more cloth thermal insulators, such that the absorber is not in contact with the aperture, is not in contact with the housing, and is not in contact with the retainer body.

32. (canceled)
